(19) United States
(12) Patent Application Publication
(10) Pub. No.: US 2014/0089566 A1
(43) Pub. Date: Mar. 27, 2014

(54) DATA STORING METHOD, AND MEMORY CONTROLLER AND MEMORY STORAGE APPARATUS USING THE SAME

(71) Applicant: PHISON ELECTRONICS CORP., Miaoli (TW)

(72) Inventors: Chao-Han Wu, Miaoli (TW); Kim-Hon Wong, Hsinchu County (TW); Kheng-Chong Tan, Miaoli (TW)

(73) Assignee: PHISON ELECTRONICS CORP., Miaoli (TW)

(21) Appl. No.: 13/670,480

(22) Filed: Nov. 7, 2012

(30) Foreign Application Priority Data
Sep. 25, 2012 (TW) 101135146

(51) Int. Cl. G06F 12/00

(52) U.S. Cl. 711/103; 711/E12.008

(57) ABSTRACT

A data storing method and a memory controller and a memory storage apparatus using the same are provided. The method includes logically grouping physical erase units into a data area and a spare area; selecting a physical erase unit form the spare area as a first data collecting unit; and selecting a physical erase unit from the spare area as a second data collecting unit. The method also includes writing data received from a host into the first data collecting unit. The method further includes performing a data arranging operation to move valid data in a third physical erase unit to the second data collecting unit and associating the third physical erase unit with the spare area. Accordingly, the method can effectively enhance the performance of the write operation.

### CROSS-REFERENCE TO RELATED APPLICATION

This application claims the priority benefit of Taiwan application serial no. 101135146, filed on Sep. 25, 2012. The entirety of the above-mentioned patent application is hereby incorporated by reference herein and made a part of this specification.

### BACKGROUND

1. Technology Field

The present invention relates to a data storing method for a non-volatile memory module and a memory controller and a memory storage apparatus using the same.

2. Description of Related Art

The growth of digital cameras, mobile phones, and MP3 players has been rapid in recent years. Consequently, the consumers' demand for storage media has increased tremendously. Rewritable non-volatile memory is one of the most adaptable memories for portable electronic products such as laptop computer due to its data non-volatility, low power consumption, small volume, non-mechanical structure and high read/write speed. A solid state drive is a storage apparatus adopting flash memory module as storage medium. For these reasons, flash memory has become an import part of the electronic industries.

The flash memory storage module has a plurality of physical blocks, and each physical block has a plurality of physical pages, wherein data must be written into a physical block according to the sequence of the physical pages in the physical block. In addition, the physical pages being written with data must be erased before it can be used again for writing data. In particular, the physical block is served as the smallest unit for erasing data, whereas the physical page is served as the smallest unit for programming (or writing). Therefore, generally, in a flash memory module management, the physical blocks may at least be divided into a data area and a spare area.

The physical blocks of the data area (i.e., data physical areas) are used for storing the data stored by the host system. To be more specific, the memory management circuit of the flash memory apparatus may map logical addresses accessed by the host system to the physical pages of the physical blocks in the data area. Namely, in the flash memory module management, the physical blocks of the data area are regarded as the used physical blocks (e.g., already stored with data written by the host system). For example, the memory management circuit may use a logical address-physical address mapping table to record mapping relations between the logical addresses and the physical pages of the physical blocks of the data area, so as to facilitate accessing.

The physical blocks of the spare area (also refer to as a spare physical block) are used as alternate of the physical blocks of the data area. More specifically, as described above, the physical blocks written with data must be erased before being used again for writing data, and the physical pages of the physical blocks of the spare area are designed for writing update data to substitute the physical page of the local addresses previously being mapped. Accordingly, the physical blocks in the spare area are either blank or available physical units, namely, no data recorded or data marked as invalid.

More specifically, when the host system attempts to update data in a logical address, the memory management circuit of the flash memory apparatus gets a blank physical block as a temporary physical block, writes the update data into a physical page of the temporary physical block, re-maps the logical address to said physical page for writing update data and marks the physical page previously mapped to the logical address as invalid. When the temporary physical block is filled with data, the physical block served as the temporary physical block is associated with the data area, and another blank physical block is gotten from the spare area as the temporary physical block. More specifically, when the physical blocks of the spare area are exhausted, the physical blocks stored with invalid data needed to be recycled by the memory management of the flash memory apparatus. However, in the host system, a writing operation is performed using logical addresses, and a sequence for writing data to the logical addresses may not always in accordance to a sequence of the logical addresses. Therefore, a method to move valid data in the data area quickly for acquiring available physical blocks is one of the major subjects in the industry.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The present invention is directed to a data storing method, and a memory controller and a memory storage apparatus using the same, which may effectively increase overall performance of the data writing operation.

According to an exemplary embodiment of the present invention, a data storing method for a rewritable non-volatile memory module is provided, wherein the rewritable non-volatile memory module has a plurality of physical erase units, and each of the physical erase units has a plurality of physical program units. The data storing method includes: logically grouping at least a portion of the physical units into a data area and a spare area; selecting a first physical erase unit from the physical erase units of the spare area to serve as a first data collecting unit; and selecting a second physical erase unit from the physical erase units of the spare area to serve as a second data collecting unit. The data storing method further includes: receiving write data from a host system; writing the write data into the physical program units of the first physical erase unit served as the first data collecting unit. The data storing method further includes: performing a data arranging operation, wherein the data arranging operation includes selecting a third physical erase unit from the data area; moving valid data in the third physical erase unit to the physical program units of the second physical erase unit served as the second data collecting unit; and associating the third physical erase unit with the spare area. Herein, the physical program units of the second data collecting unit are written with data belonged to a plurality of non-sequential logical addresses.

According to an exemplary embodiment of the present invention, a memory controller for controlling a rewritable non-volatile memory module is provided, wherein the rewritable non-volatile memory module has a plurality of physical erase units, and each of the physical erase units has a plurality of physical program units. The memory controller includes a host interface, a memory interface and a memory management circuit. The host interface is configured to couple to a host system. The memory interface is configured to couple to the rewritable non-volatile memory module. The memory management circuit is coupled to the host interface and the memory interface. The memory management circuit is configured to logically group at least a portion of the physical erase units into a data area and a spare area; select a first physical erase unit from the physical erase units of the spare area to serve as a first data collecting unit; and select a second physical erase unit from the physical erase units of the spare area to serve as a second data collecting unit. In addition, the memory management circuit is further configured to receive write data and writing the write data into the physical program units of the first physical erase unit served as the first data collecting unit. Furthermore, the memory management circuit is further configured to perform a data arranging operation to select a third physical erase unit, move valid data in the third physical erase unit to the physical program units of the second physical erase unit served as the second data collecting unit and associate the third physical erase unit with the spare area. Herein, the physical program units of the second data collecting unit are written with data belonged to a plurality of non-sequential logical addresses.

According to an exemplary embodiment of the present invention, a memory storage apparatus including a connector, a rewritable non-volatile memory module and a memory controller is provided. The connector is configured to couple to a host system. The rewritable non-volatile memory module has a plurality of physical erase units, wherein each of the physical erase units has a plurality of physical program units. The memory controller is coupled to the connector and the rewritable non-volatile memory. The memory controller is configured to logically group at least a portion of the physical erase units into a data area and a spare area; select a first physical erase unit from the physical erase units of the spare area to serve as a first data collecting unit; and select a second physical erase unit from the physical erase units of the spare area to serve as a second data collecting unit. In addition, the memory controller is further configured to receive write data and writing the write data into the physical program units of the first physical erase unit served as the first data collecting unit. Furthermore, the memory controller is further configured to perform a data arranging operation to select a third physical erase unit, move valid data in the third physical erase unit to the physical program units of the second physical erase unit served as the second data collecting unit; and associate the third physical erase unit with the spare area. Herein, the physical program units of the second data collecting unit are written with data belonged to a plurality of non-sequential logical addresses.

The data storing method, and the memory controller and the memory storage apparatus using the same in exemplary embodiments of the present invention may effectively reduce the time required for performing the data arranging operation, thereby increasing the performance of writing data.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

To make the above features and advantages of the invention more comprehensible, several embodiments accompanied with drawings are described in detail as follows.

### BRIEF DESCRIPTION OF THE DRAWINGS

FIG. 1 is a diagram of a host system and a memory storage apparatus according to an exemplary embodiment of the present invention.

FIG. 2 is a schematic diagram illustrating a computer, an input/output device and a memory storage apparatus according to an exemplary embodiment of the present invention.

FIG. 3 is a schematic diagram of a host system and a memory storage apparatus according to an exemplary embodiment of the present invention.

FIG. 4 is a schematic block diagram of the memory storage apparatus in FIG. 1.

FIG. 5 is a schematic block diagram of a memory controller according to an exemplary embodiment of the present invention.

FIG. 6 and FIG. 7 are schematic diagrams illustrating management of a memory storage apparatus according to an exemplary embodiment of the present invention.

FIG. 8 is a schematic diagram illustrating a logical address-physical program unit mapping table according to an exemplary embodiment of the present invention.

FIGS. 9 to 18 are schematic diagrams illustrating an example of writing data to update a logical address-physical address mapping table according to an exemplary embodiment of the present invention.

FIG. 19 is a schematic diagram illustrating a physical address storage status table according to an exemplary embodiment of the present invention.

FIG. 20 and FIG. 21 are schematic diagrams illustrating the data arranging operation performed according to an exemplary embodiment of the present invention.

FIG. 22 is a flowchart of a data storing method according to an exemplary embodiment of the present invention.

FIG. 23 is a flowchart illustrating a writing operation and a data arranging operation performed according to the data storing method of the exemplary embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally, a memory storage apparatus (also known as a memory storage system) includes a rewritable non-volatile memory module and a controller (also known as a control circuit). The memory storage apparatus is usually configured together with a host system so that the host system may write data into or read data from the memory storage device.

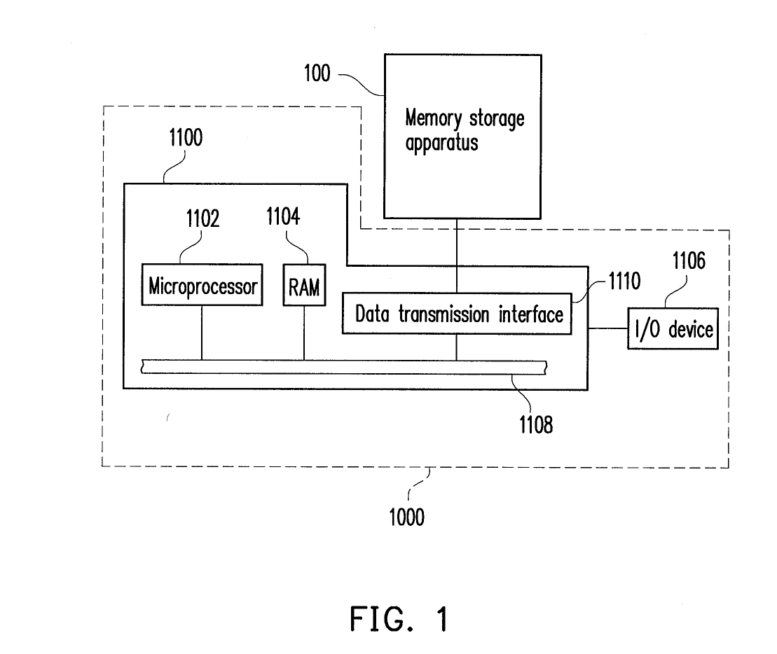

FIG. 1 is a diagram of a host system and a memory storage apparatus according to an exemplary embodiment of the present invention.

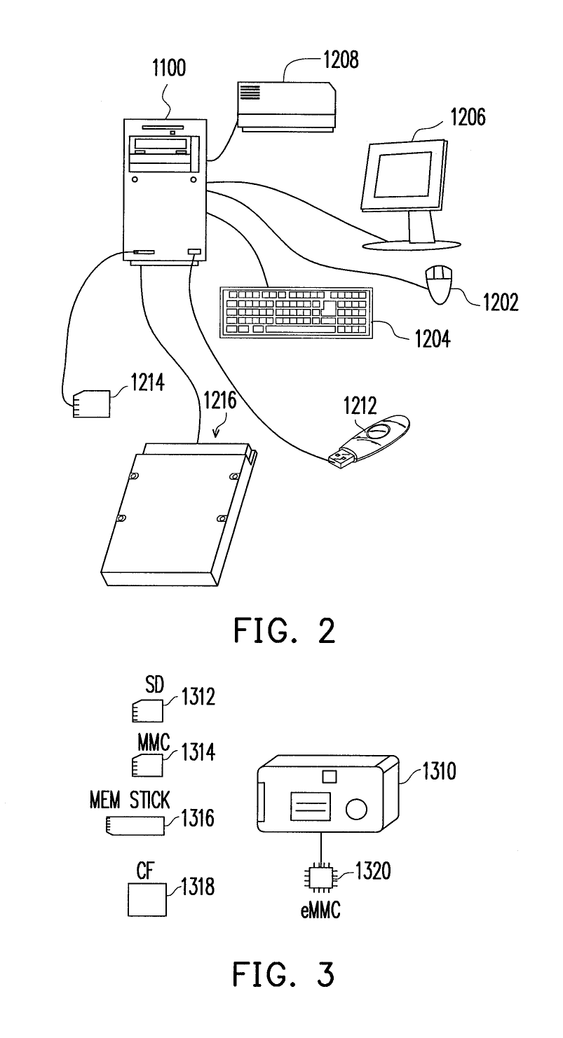

Referring to FIG. 1, a host system 1000 includes a computer 1100 and an input/output (I/O) device 1106. The computer 1100 includes a microprocessor 1102, a random access memory (RAM) 1104, a system bus 1108, and a data transmission interface 1110. For example, the I/O device 1106 includes a mouse 1202, a keyboard 1204, a display 1206 and a printer 1252 as shown in FIG. 2. It should be understood that the devices illustrated in FIG. 2 are not intended to limit the I/O device 1106, and the I/O device 1106 may further include other devices.

In the embodiment of the present invention, the memory storage apparatus 100 is coupled to the devices of the host system 1000 through the data transmission interface 1110. By using the microprocessor 1102, the random access memory (RAM) 1104 and the Input/Output (I/O) device 1106, data may be written into the memory storage apparatus 100 or may be read from the memory storage apparatus 100. For example, the memory storage apparatus 100 may be a rewritable non-volatile memory storage apparatus such as a flash drive 1256, a memory card 1214, or a solid state drive (SSD) 1216 as shown in FIG. 2.

Generally, the host system 1000 may substantially be any system capable of storing data with the memory storage apparatus 100. Although the host system 1000 is described as a computer system in the present exemplary embodiment, in another exemplary embodiment of the invention, the host system 1000 may be a digital camera, a video camera, a telecommunication device, an audio player, or a video player. For example, if the host system is a digital camera (video camera) 1310, the rewritable non-volatile memory storage apparatus may be a SD card 1312, a MMC card 1314, a memory stick 1316, a CF card 1318 or an embedded storage apparatus 1320 (as shown in FIG. 3). The embedded storage apparatus 1320 includes an embedded MMC (eMMC). It should be mentioned that the eMMC is directly coupled to a substrate of the host system.

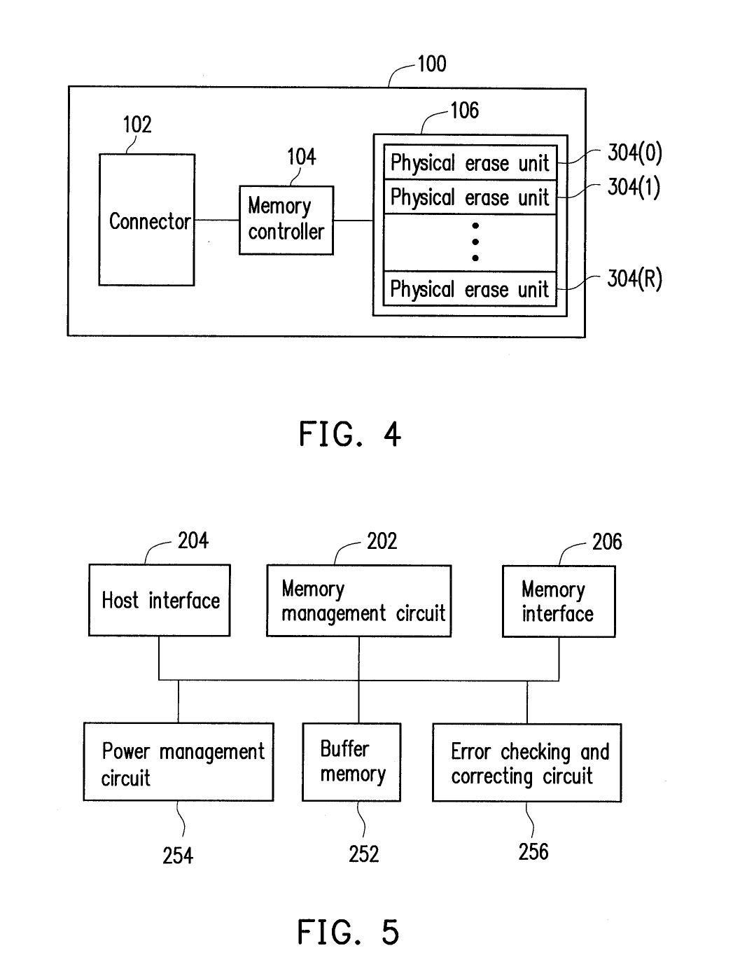

FIG. 4 is a schematic block diagram of the memory storage apparatus in FIG. 1.

Referring to FIG. 4, the memory storage apparatus 100 includes a connector 102, a memory controller 104 and a rewritable non-volatile memory storage module 106.

In the present exemplary embodiment, the connector 102 is compatible to a serial advanced technology attachment (SATA) interface standard. However, the invention is not limited thereto, and the connector 102 may also be compatible to a Parallel Advanced Technology Attachment (PATA) interface standard, an Institute of Electrical and Electronic Engineers (IEEE) 1394 interface standard, a peripheral component interconnect (PCI) Express interface standard, a universal serial bus (USB) standard, a secure digital (SD) interface standard, a Ultra High Speed-I (UHS-I) interface standard, a Ultra High Speed-II (UHS-II) interface standard, a memory sick (MS) interface standard, a multi media card (MMC) interface standard, an embedded MMC (eMMC) interface standard, a Universal Flash Storage (UFS) interface standard, a compact flash (CF) interface standard, an integrated device electronics (IDE) interface standard or other suitable standards.

The memory controller 104 is configured to execute a plurality of logic gates or control instructions which are implemented in a hardware form or in a firmware form, so as to perform operations of writing, reading or erasing data in the rewritable non-volatile memory storage module 106 according to the commands of the host 1000.

The rewritable non-volatile memory storage module 106 is coupled to the memory controller 104 and configured to store data written from the host system 1000. The rewritable non-volatile memory storage module 106 has multiple physical erase units 304(0) to 304(R). For example, the physical erase units 304(0) to 304(R) may belong to the same memory die or belong to different memory dies. Each physical erase unit has a plurality of physical program units, and the physical program units of the same physical erase unit may be may be written separately and erased simultaneous. For example, each physical erase unit is composed by 128 physical program units. Nevertheless, it should be understood that the invention is not limited thereto. Each physical erase unit may also be composed by 64 physical program units, 256 physical program units or any amount of the physical program units.

More specifically, the physical erase unit is the smallest unit for erasing. Namely, each physical erase unit contains the least number of memory cells to be erased together. The physical program unit is the smallest unit for programming. That is, the physical program unit is the smallest unit for writing data. Each physical program unit usually includes a data bits area and a redundancy bits area. The data bits area having multiple physical access address is used to store user data, and the redundant bit area is used to store system data (for example, control information and error checking and correcting code). In the present exemplary embodiment, each data bit area of the physical program unit contains 4 physical access addresses, and the size of each physical access address is 512 bytes. However, in other exemplary embodiments, more or less number of the physical address may be contained in the data bit area, amount and size of the physical access address are not limited in the present invention. For example, in an exemplary embodiment, the physical erase unit is a physical block, and the physical program unit is a physical page or a physical sector, but the present invention is not limited thereto.

In the present exemplary embodiment, a rewritable non-volatile memory module 106 is a Multi Level Cell (MLC) NAND flash memory module which stores at least 2 bits of data in one cell. However, the present invention is not limited thereto. The rewritable non-volatile memory module 106 may also be a Trinary Level Cell (TLC) NAND flash memory module, other flash memory module or other memory module having the same feature.

FIG. 5 is a schematic block diagram of a memory controller according to an exemplary embodiment of the present invention. It should be understood that, the structure of the memory controller as shown in FIG. 5 is only an example, the present invention is not limited thereto.

Referring to FIG. 5, the memory controller 104 includes a memory management circuit 202, a host interface 204 and a memory interface 206.

The memory management circuit 202 is configured to control the overall operations of the memory controller 104. Specifically, the memory management circuit 202 has a plurality of control instructions. When the memory storage apparatus 100 is operated, the control instructions are executed to perform various data operation such as data writing, data reading and data erasing.

In the present exemplary embodiment, the control instructions of the memory management circuit 202 are implemented in a firmware form. For example, the memory management circuit 202 has a microprocessor unit (not illustrated) and a ROM (not illustrated), and the control instructions are burnt into the ROM. During the operation of the memory storage apparatus 100, the control instructions are executed by the microprocessor to perform operations of writing, reading or erasing data.

In another exemplary embodiment of the present invention, the control instructions of the memory management circuit 202 may also be stored as program codes in a specific area (for example, the system area in a memory exclusively used for storing system data) of the rewritable non-volatile memory module 106. In addition, the memory management circuit 202 has a microprocessor unit (not illustrated), a ROM (not illustrated) and a RAM (not illustrated). In particular, the ROM has a activate code, which is executed by the microprocessor unit to load the control instructions stored in the rewritable non-volatile memory module 106 to the RAM of the memory management circuit 202 when the memory controller 104 is enabled. Next, the control instructions are executed by the microprocessor unit to perform operations of writing, reading or erasing data.

Further, in another exemplary embodiment of the present invention, the control instructions of the memory management circuit 202 may also be implemented in a hardware form. For example, the memory management circuit 202 includes a microprocessor, a memory cell management circuit, a memory writing circuit, a memory reading circuit, a memory erasing circuit and a data processing circuit. The memory cell management circuit, the memory writing circuit, the memory reading circuit, the memory erasing circuit and the data processing circuit are coupled to the microprocessor. The memory cell management circuit is configured to manage the physical erase unit of the rewritable non-volatile memory module 106; the memory writing circuit is configured to issue a write command to the rewritable non-volatile memory module 106 to write data into the rewritable non-volatile memory module; the memory reading circuit is configured to issue a read command to the rewritable non-volatile memory module 106 to read data from the rewritable non-volatile memory module 106; the memory erasing circuit is configured to issue an erase command to the rewritable non-volatile memory module 106 to erase data from the rewritable non-volatile memory module 106; the data processing circuit is configured to process both the data to be written into the rewritable non-volatile memory module 106 and the data to be read from the rewritable non-volatile memory module 106.

The host interface 204 is coupled to the memory management circuit 202 and configured to receive and identify commands and data sent from the host system 1000. Namely, the commands and data sent from the host system 1000 are passed to the memory management circuit 202 through the host interface 204. In the present exemplary embodiment, the host interface 204 is compatible to a SATA interface standard. However, it is to be understood that the present invention is not limited thereto. The host interface 204 may also be a PATA interface standard, an IEEE 1394 interface standard, a PCI Express standard, a USB interface standard, a SD interface standard, a UHS-I interface standard, a UHS-II interface standard, a MS interface standard, a MMC interface standard, an eMMC interface standard, a UFS interface standard, a CF interface standard, an IDE interface standard, or other suitable standards for data transmission.

The memory interface 206 is coupled to the memory management circuit 202 and configured to access the rewritable non-volatile memory module 106. That is, data to be written to the rewritable non-volatile memory module 106 is converted to a format acceptable to the rewritable non-volatile memory module 106 through the memory interface 206.

In an exemplary embodiment of the present invention, the memory controller 104 further includes a buffer memory 252, a power management circuit 254 and an error checking and correcting circuit 256.

The buffer memory 252 is coupled to the memory management circuit 202 and configured to temporarily store data and commands from the host system 1000 or data from the rewritable non-volatile memory module 106.

The power management unit 254 is coupled to the memory management circuit 202 and configured to control the power of the memory storage apparatus 100.

The error checking and correcting circuit 256 is coupled to the memory management circuit 202 and configured to perform an error checking and correcting process to ensure the correctness of data. Specifically, when the memory management circuit 202 receives a writing command from the host system 1000, the error checking and correcting circuit 256 generates an error checking and correcting code (ECC code) for data corresponding to the writing command, and the memory management circuit 202 writes data and the ECC code corresponding to the writing command into the rewritable non-volatile memory module 106. Next, when reading data from the rewritable non-volatile memory module 106, the memory management circuit 202 also reads the ECC Code corresponding to such data, and the error checking and correcting circuit 256 performs an error checking and correcting process on the read data based on the read ECC code.

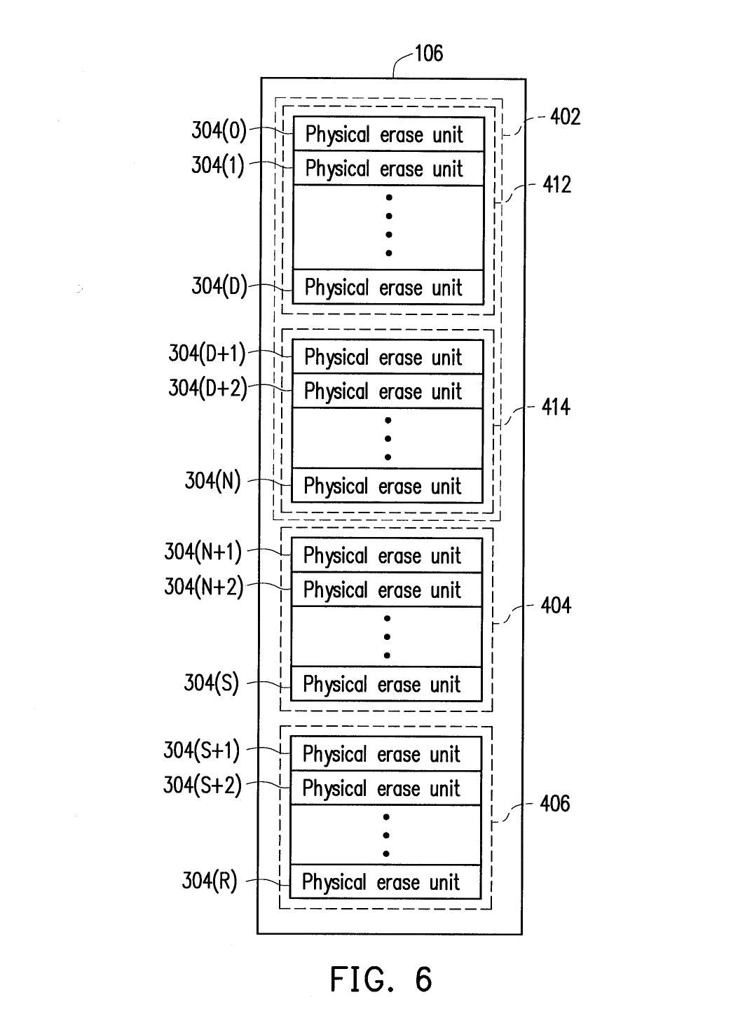

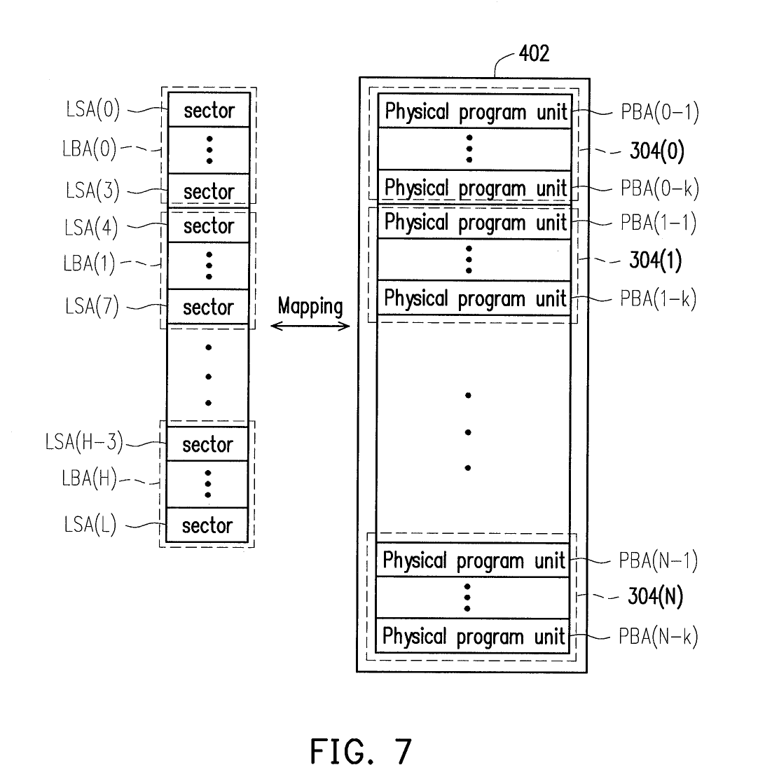

FIG. 6 and FIG. 7 are schematic diagrams illustrating management of a memory storage apparatus according to an exemplary embodiment of the present invention.

It should be understood that terms, such as “get”, “select”, “exchange”, “group”, “alternate” and so forth, are logical concepts which describe operations in the physical erase units of the rewritable non-volatile memory module 106. That is, the physical erase units of the rewritable non-volatile memory module are logically operated, but actual positions of the physical units of the rewritable non-volatile memory module are not changed.

Referring to FIG. 6, the memory controller 104 (or the memory management circuit 202) may logically group the physical erase units 304(0) to 304(R) of the rewritable non-volatile memory module 106 into a storage area 402, a system area 404 and a replacement area 406.

Logically, the physical erase units belonged to the storage area 402 is used for storing data written from the host system 1000. Namely, the memory storage apparatus 100 practically stores data written from the host system 1000 by using physical erase units grouped as the storage area 402. More specifically, the memory controller 104 (or the memory management circuit 202) divides the storage area 402 into a data area 412 and a spare area 414, in which a physical erase unit (also known as a data physical erase unit) of the data area 412 is a physical erase unit stored with data, and a physical erase unit (also known as a spare physical erase unit) of the spare area 414 is a physical erase unit used for substituting the data area 412. Therefore, the physical erase units of the spare area 414 are either blank or available physical erase units (i.e., no data recorded or data marked as invalid). In other words, an erasing operation is performed to the physical erase unit of the spare area, or an erasing operation is performed to the gotten physical erase unit of the spare area 414 before this physical erase unit is used for storing data. Therefore, the physical erase units of the spare area 414 are available physical erase units. More specifically, when one physical erase unit is selected from the spare area 414 for storing valid data, such physical erase unit is then associated with the data area 412. Also, the memory controller 104 (or the memory management circuit 202) may perform the erasing operation to a physical erase unit, all data stored into which is invalid, in the data area 412, and associate the erased physical erase unit with the spare area 414, so that said physical erase unit may be alternately used for storing data written from the host system 1000. For example, according to the present embodiment, when the memory storage apparatus 100 is initialized (i.e., under a formatting process), all of the physical erase units in the storage 402 are associated with the spare area 411 (i.e., all storage spaces in the storage area 402 are available).

The physical erase units logically belonged to the system area 404 are used for recording system information, which includes information related to manufacturer and model of a memory chip, a number of physical erase units in the memory chip, the number of the physical program unit in each physical erase unit, and so forth.

The physical erase units logically belonged to the replacement area 406 are replacements to the physical erase units. For example, 4% of the physical erase units in the rewritable non-volatile memory module 106 are reserved for replacement during its manufacturing process. That is, when the physical erase units in the data area 412, the spare area 414 and the system area 404 are damaged, the physical erase units reserved in the replacement area 406 are used for replacing the damaged physical erase units (i.e., bad blocks). Thus, if available physical erase units are present in the replacement area 406 while the physical erase units being damaged, the memory controller 104 may select an available physical erase unit from the replacement area 406 to replace the damaged physical erase unit. If no available physical erase units are present in the replacement area 406 while the physical erase unit being damaged, the memory storage apparatus 100 is announced by the memory controller 104 as being in a write-protect status, and data cannot be written therein.

In particular, the amount of the physical erase units in the storage area 402, the system area 404 and the replacement area 406 may be different according to the different memory standards. In addition, it should be understood that, the grouping relationships of grouping the physical erase units into the storage area 402, the system area 404, and the replacement area 406 are dynamically changed during the operation of the memory storage apparatus 100. For example, when damaged physical erase units in the storage area 402 are replaced by the physical erase unit in the replacement area 406, the physical erase unit originally from the replacement area 406 is then associated with the storage area 402.

Referring to FIG. 7, as described above, the physical erase units of the data area 412 and the spare area 414 are used for storing data written from the host system 1000. In the present exemplary embodiment, the memory controller 104 (or the memory management circuit 202) assigns logical addresses LBA(0) to LBA(H) to the host system 1000 for data accessing.

Each logical address is composed by several sectors. For example, in the present exemplary embodiment, each logical address is composed by four sectors. For example, sectors LSA(0) to LSA(3) belong to the logical address LBA(0); sectors LSA(4) to LSA(7) belong to the logical address LBA(1); and sectors LSA(8) to LSA(11) belong to the logical address LBA(2). However, the present invention is not limited thereto. In another exemplary embodiment of the present invention, the logical address may be composed by 8 sectors or 16 sectors.

For example, the memory controller 104 (or the memory management circuit 202) maintains a logical address-physical address mapping table to record a mapping relation between the logical addresses and the physical program units. In other words, when the host system 1000 accesses data in the sector, the memory controller 104 (or the memory management circuit 202) may first identify the logical address belonged to such sector and accesses data from the physical program unit mapped with such logical address.

According to the present exemplary embodiment, the memory controller 104 (or the memory management circuit 202) may select one physical erase unit from the spare area 414 to serve as a first data collecting unit before a writing command is executed and data are written into the first data collecting unit. When the physical erase unit served as the first data collecting unit is filled with data, the memory controller 104 (or the memory management circuit 202) may associate the physical erase unit with the data area 412 and select another physical erase unit from the spare area 414 to serve as the first data collecting unit.

For example, when the memory controller 104 (or the memory management circuit 202) starts to store data written from the host system 1000 by using the physical erase unit 304(0) served as the first data collecting unit, regardless of which logical address is selected by the host system 1000 for writing, the memory controller 104 (or the memory management circuit 202) sequentially writes data into the physical, program units of the physical erase unit 304(0); and when the memory controller 104 (or the memory management circuit 202) starts to store data written from the host system 1000 by using the physical erase unit 304(1) served as the first data collecting unit, regardless of which logical address is selected by the host system 1000 for writing, the memory controller 104 (or the memory management circuit 202) sequentially writes data into the physical program units of the physical erase unit 304(1). In other words, when the host system 1000 is about to write data, the memory controller 104 (or the memory management circuit 202) may sequentially use the physical erase unit among the physical program units served as the first data collecting unit to write data. Only when all of the physical program units in the physical erase unit are used, another physical erase unit without storing any data may then be selected as the first data collecting unit for sequentially writing data. According to the present exemplary embodiment, when data are written into the memory controller 104 (or the memory management circuit 202), the memory controller 104 (or the memory management circuit 202) may update the logical address-physical address mapping table to correctly record the mapping relations between the logical addresses and the physical program units.

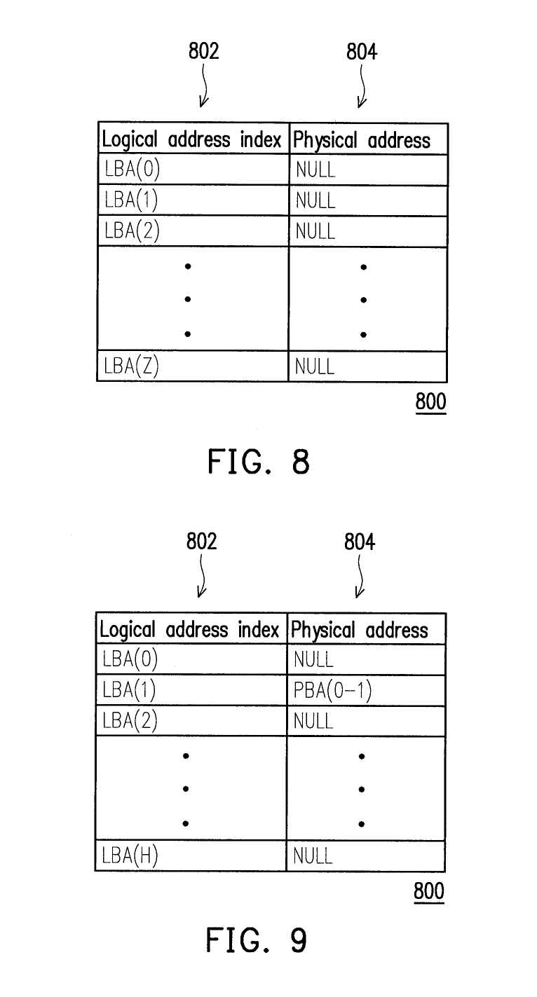

FIG. 8 is a schematic diagram illustrating a logical address-physical address mapping table according to an exemplary embodiment of the present invention.

Referring to FIG. 8, the logical address-physical address mapping table 800 includes a logical address field 802 and a physical address field 804. The logical address field 802 records each reference number of the logical address being arranged and the physical address field 804 records each of the physical program units mapped with the logical address. In the case where the memory storage apparatus 100 is brand new and never used for storing data, the physical erase units 304(0) to 304(N) are associated with the spare area 414, and each field corresponding to each of the physical program units mapped to the logical address in all of the logical address-physical address mapping table is marked as void value (e.g., NULL).

FIGS. 9 to 18 are schematic diagrams illustrating an example of writing data to update a logical address-physical address mapping table according to an exemplary embodiment of the present invention. For the convenience of illustration, it is exemplified hereinafter using a storage space of a physical erase unit being composed of 5 physical program units. Nevertheless, it should be understood that the invention is not limited thereto.

Referring to FIG. 9, when the host system 1000 is about to store data to the logical address LBA(1) in the status as shown in FIG. 8, the memory controller 104 (or the memory management circuit 202) may select one physical erase unit (e.g., the physical erase unit 304(0)) from the spare area 414 to serve as the first data collecting unit, and write data to be written from the host system 1000 into the physical program unit PBA(0-1) of the physical erase unit 304(0). After data writing is completed, the memory controller 104 (or the memory management circuit 202) maps the logical address LBA(1) to the physical program unit PBA(0-1) in the logical address-physical address mapping table 800.

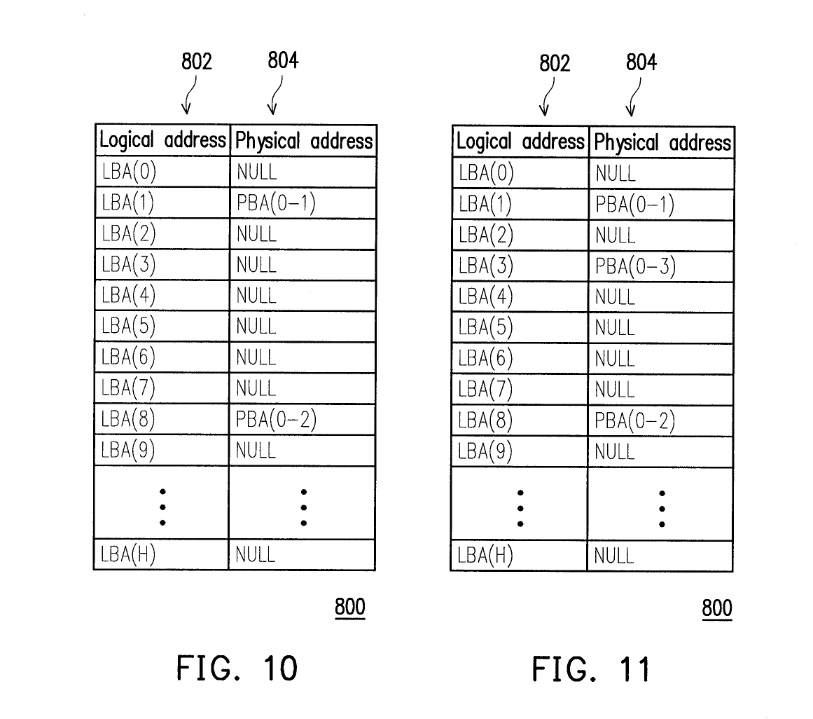

Referring to FIG. 10, when the host system 1000 is about to store data into the logical address LBA(8) in the status as shown in FIG. 8, the memory controller 104 (or the memory management circuit 202) may write data to be written from the host system 1000 into the physical program unit PBA(0-2). In this case, the memory controller 104 (or the memory management circuit 202) may map the logical address LBA(8) to the physical program unit PBA(0-2) in the logical address-physical address mapping table 800.

Referring to FIG. 11, when the host system 1000 is about to store data into the logical address LBA(3) in the status as shown in FIG. 10, the memory controller 104 (or the memory management circuit 202) writes data to be written from the host system 1000 into the physical program unit PBA(0-3). In this case, the memory controller 104 (or the memory management circuit 202) may map the logical address LBA(3) to the physical program unit PBA(0-3) in the logical address-physical address mapping table 800.

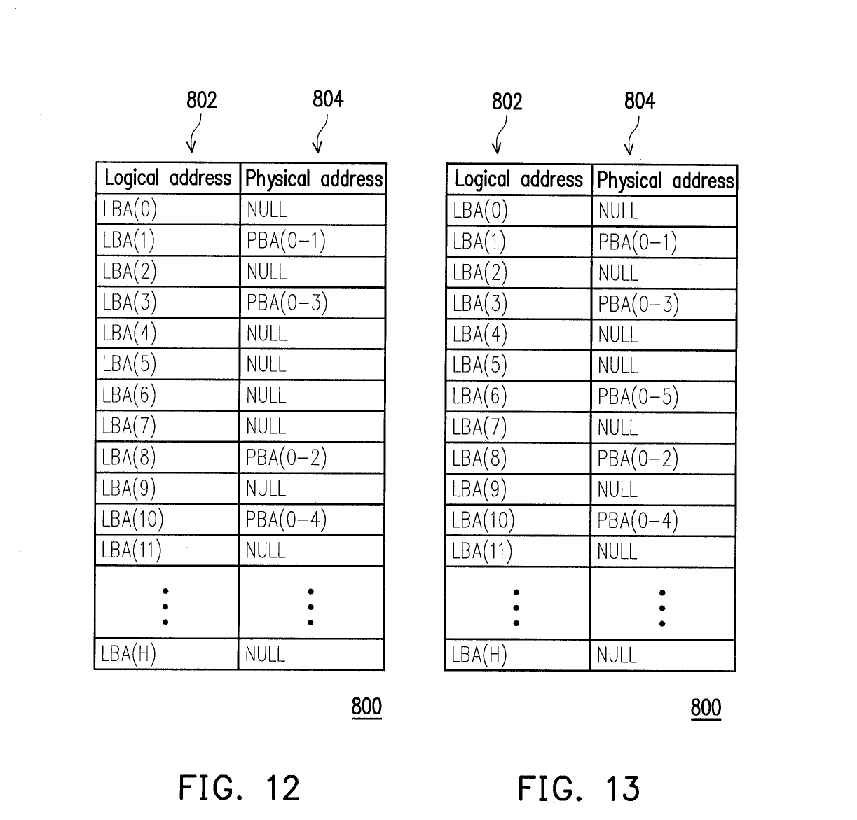

Referring to FIG. 12, when the host system 1000 is about to store data into the logical address LBA(10) in the status as shown in FIG. 11, the memory controller 104 (or the memory management circuit 202) writes data to be written from the host system 1000 into the physical program unit PBA(0-4). In this case, the memory controller 104 (or the memory management circuit 202) may map the logical address LBA(10) to the physical program unit PBA(0-4) in the logical address-physical address mapping table 800.

Referring to FIG. 13, when the host system 1000 is about to store data into the logical address LBA(6) in the status as shown in FIG. 12, the memory controller 104 (or the memory management circuit 202) writes data to be written from the host system 1000 into the physical program unit PBA(0-5). In this case, the memory controller 104 (or the memory management circuit 202) may map the logical address LBA(6) to the physical program unit PBA(0-5) in the logical address-physical address mapping table 800. In particular, the physical erase unit 304(0) served as the first data collecting unit is filled with data, so the memory controller 104 (or the memory management circuit 202) may associate the physical erase unit 304(0) with the data area 412.

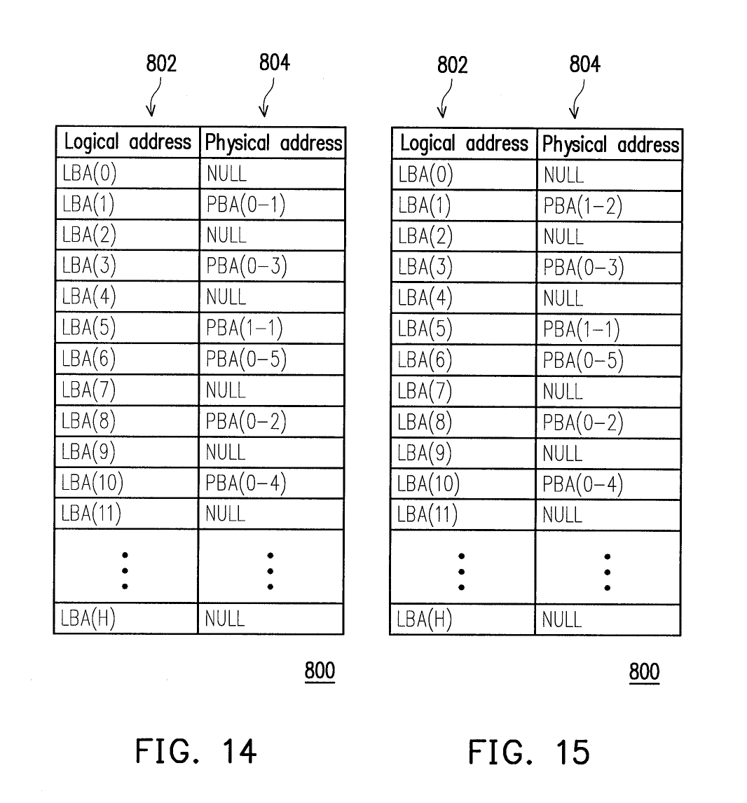

Referring to FIG. 14, when the host system 1000 is about to store data to the logical address LBA(5) in the status as shown in FIG. 13, since the physical erase unit 304(0) served as the physical first data collecting unit is filled with data and associated with the data area 412, the memory controller 104 (or the memory management circuit 202) may select another physical erase unit (e.g., the physical erase unit 304(1)) from the spare area 414 to serve as the first data collecting unit, and write data to be written from the host system 1000 into the physical program unit PBA(1-1) of the physical erase unit 304(1). Whereas the memory controller 104 (or the memory management circuit 202) may map the logical address LBA(5) to the physical program unit PBA(1-1) in the logical address-physical address mapping table 800.

Referring to FIGS. 9 to 14, the memory controller 104 (or the memory management circuit 202) sequentially writes data written from the host system 1000 using a physical erase unit served as the first data collecting unit, and only when said physical erase unit is filled with data, the memory controller 104 (or the memory management circuit 202) uses another physical erase unit as the first data collecting unit to write data continuously. In other words, data to be stored to a plurality of non-sequential logical addresses are then sequentially written into the first data collecting unit until the first data collecting unit is filled with data.

Referring to FIG. 15, when the host system 1000 is about to write data into the logical address LBA(1) in the status as shown of FIG. 14, the memory controller 104 (or the memory management circuit 202) may write data to be written from the host system 1000 into the physical program unit PBA(1-2) of the physical erase unit 304(1), and map the logical address LBA(1) to the physical program unit PBA(1-2). In this case, data stored in the physical program unit PBA(0-1) becomes an invalid data.

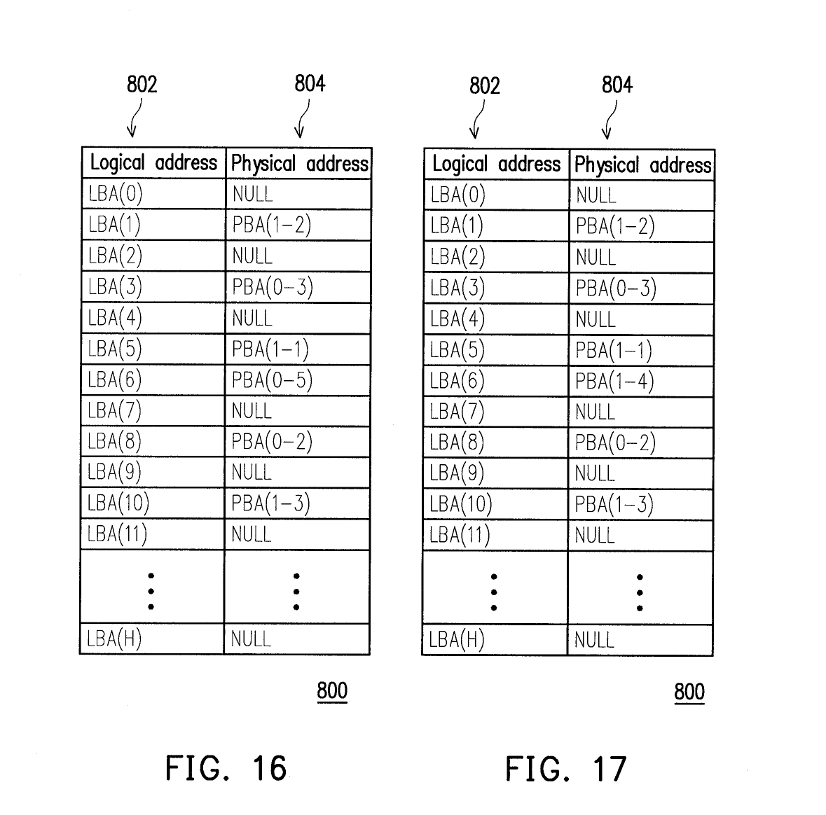

Referring to FIG. 16, when the host system 1000 is about to store data into the logical address LBA(10) in the status as shown in FIG. 15, the memory controller 104 (or the memory management circuit 202) writes data to be written from the host system 1000 into the physical program unit PBA(1-3). In this case, the memory controller 104 (or the memory management circuit 202) may map the logical address LBA(10) to the physical program unit PBA(1-3) in the logical address-physical address mapping table 800.

Referring to FIG. 17, when the host system 1000 is about to write data into the logical address LBA(6) in the status as shown of FIG. 16, the memory controller 104 (or the memory management circuit 202) may write data to be written from the host system 1000 into the physical program unit PBA(1-4) of the physical erase unit 304(1), and map the logical address LBA(6) to the physical program unit PBA(1-4). In this case, data stored in the physical program unit PBA(0-5) becomes invalid data.

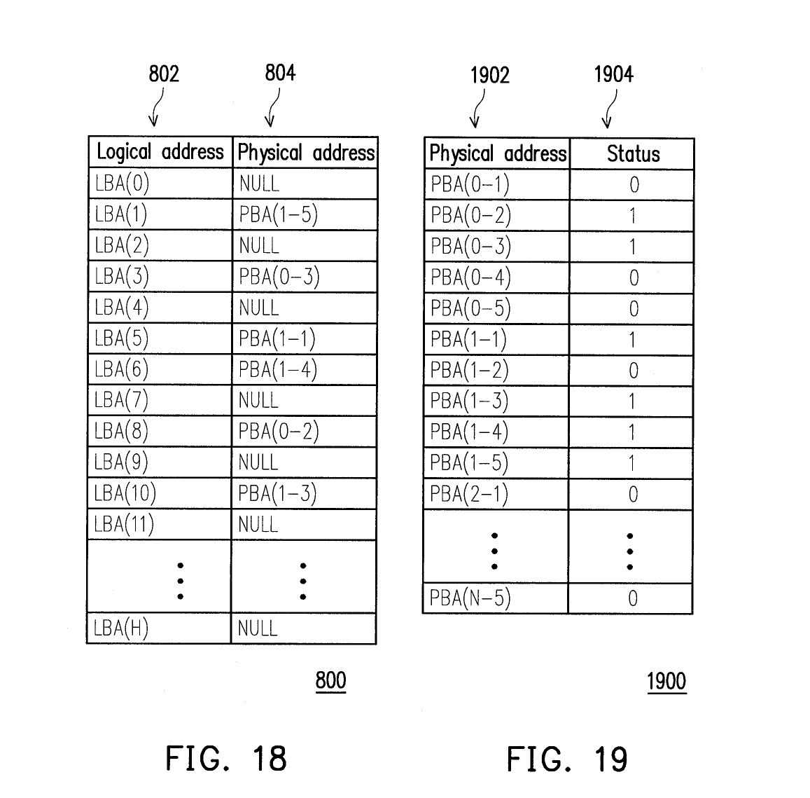

Referring to FIG. 18, when the host system 1000 is about to write data into the logical address LBA(1) in the status as shown of FIG. 17, the memory controller 104 (or the memory management circuit 202) may write data to be written from the host system 1000 into the physical program unit PBA(1-5) of the physical erase unit 304(1), and map the logical address LBA(1) to the physical program unit PBA(1-5). In this case, data stored in the physical program unit PBA(1-2) becomes an invalid data. In particular, the physical erase unit 304(1) served as the first data collecting unit is filled with data, so the memory controller 104 (or the memory management circuit 202) may associate the physical erase unit 304(1) with the data area 412.

According to the present exemplary embodiment, in order to identify the physical program unit stored with the invalid data, the memory controller 104 (or the memory management circuit 202) may maintain the physical address information table, so as to identify whether data stored in each physical address is valid data or invalid data. For example, the memory controller 104 (or the memory management circuit 202) records the status of the physical address using a physical address storage status table.

FIG. 19 is a schematic diagram illustrating a physical address storage status table according to an exemplary embodiment of the present invention, in which the physical address storage status table is corresponding to the storing states as shown in FIG. 18.

Referring to FIG. 19, a physical address storage status table 1900 includes a physical address index field 1902 and a status field 1904, in which the physical address index field 1902 records reference number of each of physical program units and the status field 1904 records status of each corresponding physical program units. For example, when the status field is marked as “0”, the corresponding data stored in the physical program unit is invalid data. When the status field is marked as “1”, the corresponding data stored in the physical program unit is valid data. However, the invention is not limited thereto.

It is noted that, besides using the physical address storage status table 1900 to identify the status of the physical address, in another exemplary embodiment of the present invention, the physical address mapping table may also be used to identify the status of the physical address. For example, the physical address mapping table includes a physical address index field and a logical address field, in which the logical address field is configured to record the logical address mapped to the physical program units recorded in the physical address index field. Further, by comparing the logical address mapping table and the physical address mapping table, data stored in each of the physical program units being valid data or invalid data may then be identified.

Based on above, when the first data collecting unit is filled with data, the memory controller 104 (or the memory management circuit 202) may select another physical erase unit from the spare area 414 to serve as the first data collecting unit. However, the amount of the physical erase unit in the spare area 414 is limited. Therefore, in the case where the amount of the physical erase units of the spare area is smaller than the predetermined threshold value, a data arranging operation is performed by the memory controller 104 (or the memory management circuit 202) to re-use the physical erase units stored with invalid data in the data area. For instance, the predetermined threshold may be set to 5. Nevertheless, it should be understood that the present invention is not limited thereto, and the predetermined threshold may be other appropriate values.

According to the present exemplary embodiment, the memory controller 104 (or the memory management circuit 202) selects a physical erase unit from the spare area 414 to serve as a second data collecting unit and writes data into the physical erase unit served as the second data collecting unit when the data arranging operation is performed.

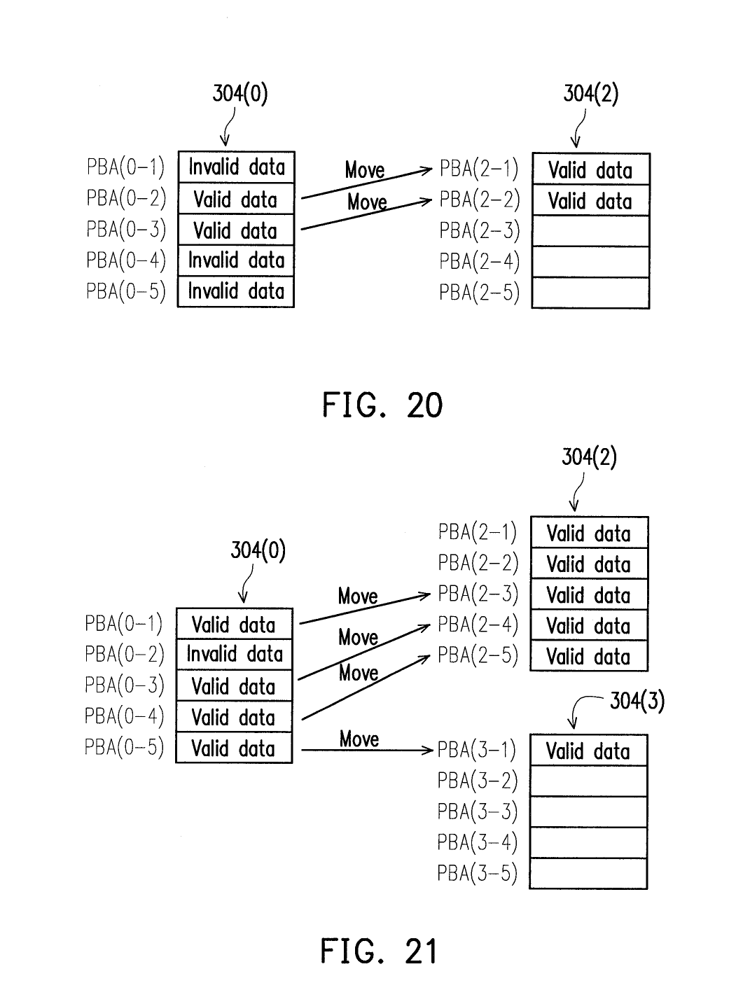

FIG. 20 and FIG. 21 are schematic diagrams illustrating the data arranging operation performed according to an exemplary embodiment of the invention.

Referring to FIG. 20, the memory controller 104 (or the memory management circuit 202) selects one physical erase unit (e.g., the physical erase unit 304(0)) from the data area 412 to serve as a target to perform a data merging operation.

For example, the memory controller 104 (or the memory management circuit 202) may record a valid data rate of each physical erase unit. Herein, the valid data rate of one physical erase unit is defined as a proportion of physical program units stored with valid data in all physical program units of the physical erase unit. Also, the memory controller 104 (or the memory management circuit 202) may select a physical erase unit having the lowest valid data rate from the data area 412 as a target to perform the data arranging operation. For example, the memory controller 104 (or the memory management circuit 202) may calculate the valid data rate of each physical erase unit according to the physical address storage status table 1900 above.

Next, the memory controller 104 (or the memory management circuit 202) may move valid data in the physical erase unit 304(0) to the second data collecting unit. For example, it is assumed that the physical program unit PBA(0-2) of the physical erase unit 304(0) is stored with valid data belonged to the logical address LBA(8), the physical program unit PBA(0-3) of the physical erase unit 304(0) is stored with valid data belonged to the logical address LBA(3) and the physical erase unit 304(0) is selected by the memory controller 104 (or the memory management circuit 202) from the spare area 414 as the second data collecting unit. In this case, the memory controller 104 (or the memory management circuit 202) may then perform the following operations: moving data in the physical program unit PBA(0-2) of the physical erase unit 304(4) to the physical program unit PBA(2-1) of the physical erase unit 304(2); re-mapping the logical address LBA(8) to the physical program unit PBA(2-1); moving data in the physical program unit PBA(0-3) of the physical erase unit 304(4) to the physical program unit PBA(2-2) of the physical erase unit 304(2); re-mapping the logical address LBA(3) to the physical program unit PBA(2-2); and associating the physical erase unit 304(0) with the spare area 414, so as to complete the data arranging operation. Herein, while moving valid data from the original physical program unit to another physical program unit, said original physical program unit is marked as the physical program unit stored with invalid data.

Similarly, in the case where the data arranging operation is to be performed again during operating processes of the memory storage apparatus, the memory controller (or the memory management circuit 202) may again select one physical erase unit as the target to the data arranging operation, and valid data of the physical erase unit may be continued to write into the physical erase unit being served as the second data collecting unit.

Referring to FIG. 21, it is assumed that in the physical erase unit 304(1) served as the target to the data arranging operation, the physical program unit PBA(1-1) is stored with valid data belonged to the logical address LBA(5), the physical program unit PBA(1-3) is stored with valid data belonged to the logical address LBA(10), the physical program unit PBA(1-4) is stored with valid data belonged to the logical address LBA(6) and the physical program unit PBA(1-5) is stored with valid data belonged to the logical address LBA(1). In this case, the memory controller 104 (or the memory management circuit 202) may then perform the following operations: moving data in the physical program unit PBA(1-1) to the physical program unit PBA(2-3) of the physical erase unit 304(2) served as the second data collecting unit; re-mapping the logical address LBA(5) to the physical program unit PBA(2-3); moving data in the physical program unit PBA(1-3) to the physical program unit PBA(2-4) of the physical erase unit 304(2); re-mapping the logical address LBA(10) to the physical program unit PBA(2-4); moving data in the physical program unit PBA(1-4) to the physical program unit PBA(2-5) of the physical erase unit 304(2); re-mapping the logical address LBA(6) to the physical program unit PBA(2-5). Since the physical erase unit 304(2) served as the second data collecting unit is filled with data, the memory controller 104 (or the memory management circuit 202) may associate the physical erase unit 304(2) with the data area 412 and select another physical erase unit (e.g., the physical erase unit 304(3)) from the spare area 414 to serve as the second data collecting unit. Next, the memory controller 104 (or the memory management circuit 202) may then perform the following operations: moving data in the physical program unit PBA(1-5) to the physical program unit PBA(3-1) of the physical erase unit 304(3); re-mapping the logical address LBA(1) to the physical program unit PBA(3-1); and associating the physical erase unit 304(1) with the spare area 414, so as to complete the data arranging operation.

As illustrated in FIG. 20 and FIG. 21, the memory controller 104 (or the memory management circuit 202) may sequentially write valid data moved by the data arranging operation using a physical erase unit served as the second data collecting unit, and only when said physical erase unit is filled with data, data may then be continued to write by the memory controller 104 (or the memory management circuit 202) using another physical erase unit as the second data collecting unit. In other words, valid data belonged to a plurality of non-sequential logical addresses may be sequentially moved to the second data collecting unit until the second data collecting unit is filled with data.

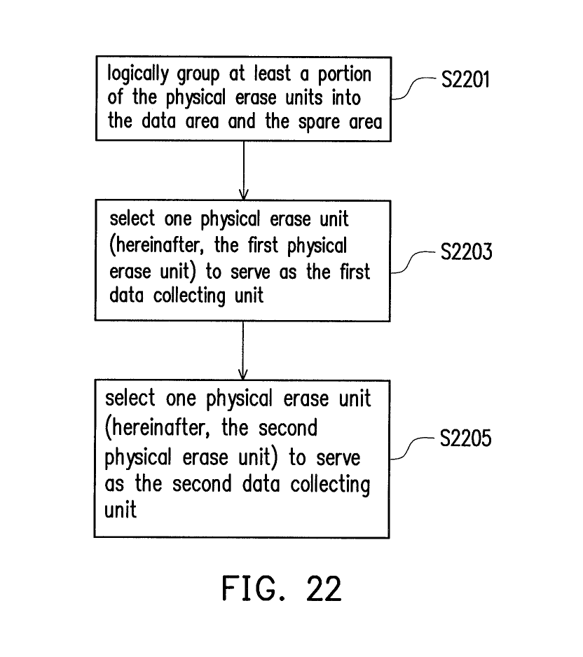

FIG. 22 is a flowchart illustrating an arrangement of physical erase units according to the data storing method of the exemplary embodiment of the present invention.

Referring to FIG. 22, in step S2201, the memory controller 104 (or the memory management circuit 202) logically groups at least a portion of the physical erase units into the data area 412 and the spare area 414.

In step S2203, the memory controller 104 (or the memory management circuit 202) selects one physical erase unit (hereinafter, the first physical erase unit) from the physical erase units of the spare area 414 to serve as the first data collecting unit.

In step S2205, the memory controller 104 (or the memory management circuit 202) selects one physical erase unit (hereinafter, the second physical erase unit) from the physical erase units of the spare area to serve as the second data collecting unit.

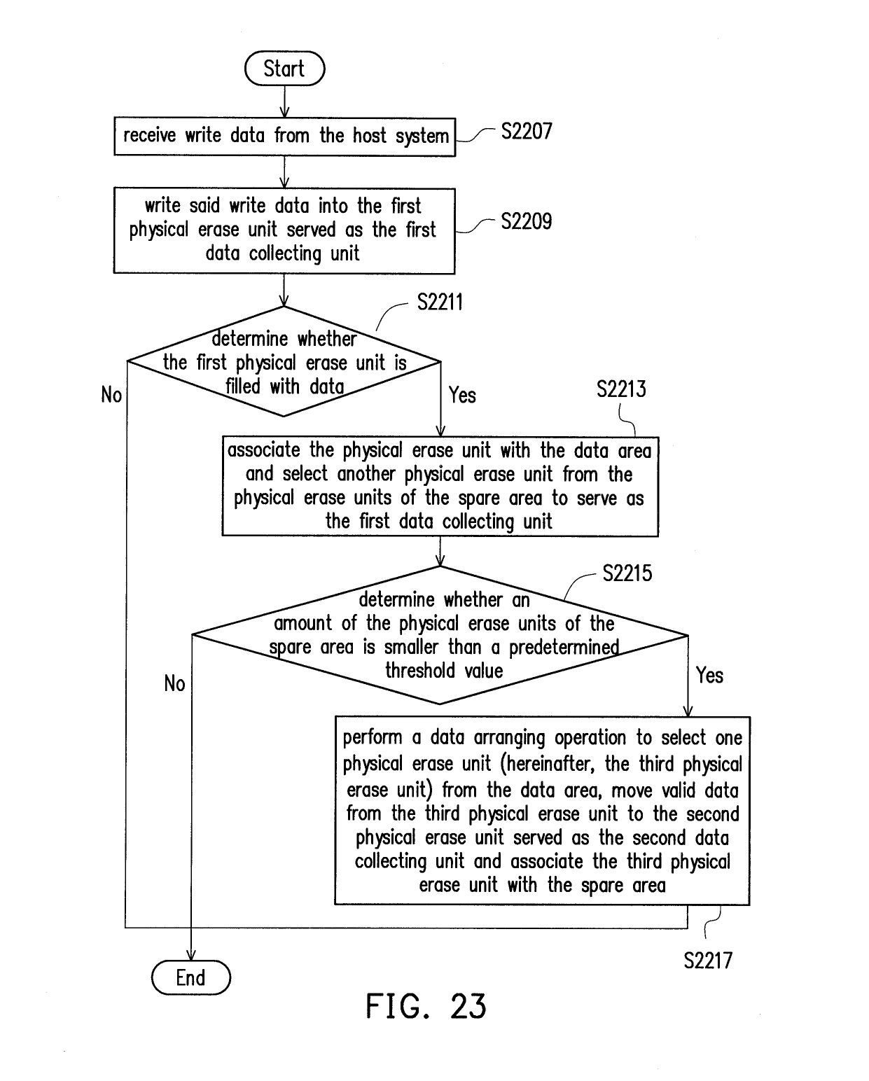

FIG. 23 is a flowchart illustrating a writing operation and a data arranging operation performed according to the data storing method of the exemplary embodiment of the present invention.

In step S2207, the memory controller 104 (or the memory management circuit 202) may receive write data from the host system 1000; and in step S2209, the memory controller (or the memory management circuit 202) may write said write data into the first physical erase unit served as the first data collecting unit.

In step S2211, the memory controller 104 (or the memory management circuit 202) may determine whether the first physical erase unit is filled with data.

The processes in FIG. 22 is terminated when the physical erase unit served as the first data collecting unit is not filled with data.

In case of the physical erase unit served as the first data collecting unit being filled with data, in step S2213, the memory controller 104 (or the memory management circuit 202) may associate the physical erase unit with the data area 412 and select another physical erase unit from the physical erase units of the spare area 414 to serve as the first data collecting unit.

Next in step S2215, the memory controller 104 (or the memory management circuit 202) may determine whether an amount of the physical erase units of the spare area 414 is smaller than a predetermined threshold value.

The processes in FIG. 22 is terminated when the amount of the physical erase units of the spare area 414 is not smaller than the predetermined threshold value.

In case of the amount of the physical erase units of the spare area 414 being smaller than the predetermined threshold value, in step S2217, the memory controller 104 (or the memory management circuit 202) may perform the data arranging operation to select one physical erase unit (hereinafter, the third physical erase unit) from the data area, move valid data from the third physical erase unit to the second physical erase unit served as the second data collecting unit and associate the third physical erase unit with the spare area. Next, the process in the FIG. 22 is then terminated.

Particularly in step S2217, the memory controller 104 (or the memory management circuit 202) may determine whether the second physical erase unit is filled with data, and in case of the second physical erase unit being filled with data, the memory controller 104 (or the memory management circuit 202) may select another physical erase unit from the physical erase units of the spare area 414.

As described above, the data storing method, and the memory controller and the memory storage apparatus using the same in exemplary embodiments of the present invention may arrange a first data collecting unit for writing data written from the host system and arrange a second data collecting unit to write valid data moved by a data arranging operation. In particular, since valid data moved by the data arranging operation is not updated, a storing mechanism according to the embodiments of the present invention may be used to gradually move valid data to a portion of the data erasing units, and gradually move invalid data to another portion of the data erasing units. As a result, when a data erasing unit capable of storing new data is obtained in the subsequent data arranging operation, the data arranging operation may be performed by selecting a physical erase unit having a lower valid data rate, so as to reduce time required for performing the data arranging operation. The previously described exemplary embodiments of the present invention have the advantages aforementioned, wherein the advantages aforementioned not required in all versions of the invention.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A data storing method for a rewritable non-volatile memory module, the rewritable non-volatile memory module has a plurality of physical erase units, and each of the plurality of physical erase units has a plurality of physical program units, the data storing method comprising:
logically grouping at least a portion of the physical units into a data area and a spare area;
selecting a first physical erase unit from the physical erase units of the spare area to serve as a first data collecting unit;
selecting a second physical erase unit from the physical erase units of the spare area to serve as a second data collecting unit;
receiving write data from a host system;
writing the write data into the physical program units of the first physical erase unit served as the first data collecting unit; and
performing a data arranging operation, wherein the data arranging operation comprises selecting a third physical erase unit from the data area; moving valid data in the third physical erase unit to the physical program units of the second physical erase unit served as the second data collecting unit; and associating the third physical erase unit to the spare area,
wherein the physical program units of the second data collecting unit are written with data belonged to a plurality of non-sequential logical addresses.

2. The data storing method of claim 1, further comprising:
associating the first physical erase unit served as the first data collecting unit with the data area when the first data collecting unit is filled with data and reselecting another physical erase unit from the physical erase units of the spare area to serve as the first data collecting unit; and
associating the second physical erase unit served as the second data collecting unit with the data area when the second data collecting unit is filled with data and re-selecting another physical erase unit from the physical erase units of the spare area to serve as the second data collecting unit.

3. The data storing method of claim 1, further comprising:
determining whether an amount of the physical erase units of the spare area is smaller than a predetermined threshold value,
wherein the step of performing the data arranging operation is performed when the amount of the physical erase units of the spare area is smaller than the predetermined threshold value.

4. The data storing method of claim 1, wherein the data arranging operation further comprises:
calculating a valid data rate in each of the plurality of physical erase unit of the data area,
wherein the valid data rate of the third physical erase unit is smaller than the valid data rates of other physical erase units of the data area.

5. The data storing method of claim 1, wherein the physical program units of the first data collecting unit are written with data belonged to the plurality of non-sequential logical addresses.

6. A memory controller for controlling a rewritable non-volatile memory module, the rewritable non-volatile memory module has a plurality of physical erase units, and each of the plurality of the physical erase units has a plurality of physical program units, the memory controller comprising:
a host interface, configured to couple to a host system;
a memory interface, configured for couple to the rewritable non-volatile memory module; and
a memory management circuit, coupled to the host interface and the memory interface,
wherein the memory management circuit is configured to logically group at least a portion of the physical erase units into a data area and a spare area,
wherein the memory management circuit is further configured to select a first physical erase unit from the physical erase units of the spare area to serve as a first data collecting unit,
wherein the memory management circuit is further configured to select a second physical erase unit from the physical erase units of the spare area to serve as a second data collecting unit,
wherein the memory management circuit is further configured to receive write data and write the write data into the physical program units of the first physical erase unit served as the first data collecting unit,
wherein the memory management circuit is further configured to perform a data arranging operation to select a third physical erase unit, move valid data in the third physical erase unit to the physical program units of the second physical erase unit served as the second data collecting unit and associate the third physical erase unit with the spare area,
wherein the physical program units of the second data collecting unit are written with data belonged to a plurality of non-sequential logical addresses.

7. The memory controller of claim 6, wherein the memory management circuit is further configured to associate the first physical erase unit served as the first data collecting unit with the data area when the first data collecting unit is filled with data and re-select another physical erase unit from the physical erase units of the spare area to serve as the first data collecting unit,
wherein the memory management circuit is further configured to associate the second physical erase unit served as the second data collecting unit with the data area when the second data collecting unit is filled with data and re-select another physical erase unit from the physical erase units of the spare area to serve as the second data collecting unit.

8. The memory controller of claim 6, wherein the memory management circuit is further configured to determine whether an amount of the physical erase units of the spare area is smaller than a predetermined threshold value,
wherein the memory management circuit performs the data arranging operation when the amount of the physical erase units of the spare area is smaller than the predetermined threshold value.

9. The memory controller of claim 6, wherein in the data arranging operation, the memory management circuit is further configured to calculate a valid data rate in each of the physical erase units of the data area,
wherein the valid data rate of the third physical erase unit is smaller than the valid data rates of other physical erase units of the data area.

10. The memory controller of claim 6, wherein the physical program units of the first data collecting unit are written with data belonged to the plurality of non-sequential logical addresses.

11. A memory storage apparatus, comprising:
a connector, configured to couple to a host system;
a rewritable non-volatile memory module, having a plurality of physical erase units, wherein each of the plurality of the physical erase units has a plurality of physical program units; and
a memory controller, coupled to the connector and the rewritable non-volatile memory,
wherein the memory controller is configured to logically group at least a portion of the physical erase units into a data area and a spare area,
wherein the memory controller is further configured to select a first physical erase unit from the physical erase units of the spare area to serve as a first data collecting unit,
wherein the memory controller is further configured to select a second physical erase unit from the physical erase units of the spare area to serve as a second data collecting unit,
wherein the memory controller is further configured to receive write data and write the write data into the physical program units of the first physical erase unit served as the first data collecting unit,
wherein the memory controller is further configured to perform a data arranging operation to select a third physical erase unit, move valid data in the third physical erase unit to the physical program units of the second physical erase unit served as the second data collecting unit and associate the third physical erase unit with the spare area.
wherein the physical program units of the second data collecting unit are written with data belonged to a plurality of non-sequential logical addresses.

12. The memory storage apparatus of claim 11, wherein the memory controller is further configured to associate the first physical erase unit served as the first data collecting unit with the data area when the first data collecting unit is filled with data and re-select another physical erase unit from the physical erase units of the spare area to serve as the first data collecting unit,
wherein the memory controller is further configured to associate the second physical erase unit served as the second data collecting unit with the data area when the second data collecting unit is filled with data and re-select another physical erase unit from the physical erase units of the spare area to serve as the second data collecting unit.

13. The memory storage apparatus of claim 11, wherein the memory controller is further configured to determine whether an amount of the physical erase units of the spare area is smaller than a predetermined threshold value,
wherein the memory controller performs the data arranging operation when the amount of the physical erase units of the spare area is smaller than the predetermined threshold value.

14. The memory storage apparatus of claim 11, wherein in the data arranging operation, the memory controller is further configured to calculate a valid data rate in each of the physical erase units of the data area,
wherein the valid data rate of the third physical erase unit is smaller than the valid data rates of other physical erase units of the data area.

15. The memory storage apparatus of claim 11, wherein the physical program units of the first data collecting unit are written with data belonged to the plurality of non-sequential logical addresses.
